(19) United States
(12) Patent Application Publication
(10) Pub. No.: US 2009/0052568 A1
(43) Pub. Date: Feb. 26, 2009

(54) QAM COMMUNICATION SYSTEM AND METHOD THEREOF AND QAM RECEIVING APPARATUS AND METHOD THEREOF

(75) Inventors: Hirofumi Uchida, Tokyo (JP); Takashi Honda, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/147,618

(22) Filed: Jun. 27, 2008

(30) Foreign Application Priority Data
Jul. 25, 2007 (JP) 2007193289
Oct. 4, 2007 (JP) 2007-260811

(51) Int. Cl. H04L 5/12; H04L 27/06

(52) U.S. Cl. 375/261; 375/298; 375/340

(57) ABSTRACT

In a quadrature amplitude modulation (QAM) communication system and corresponding method, and a QAM receiving apparatus and corresponding method, a sending apparatus that generates a sending signal adds CRC bits thereto. In a receiving apparatus, data rate is determined without a 16QAM demapping circuit and/or notification of the data rate, by 64QAM demapping a symbol string based on the received signal using a demapping circuit, independently of whether 16QAM or 64QAM was used on the sent signal. A bit string is thus obtained, and by thinning the bit string responsive to a CRC detection result of a CRC detection circuit, an output signal is provided using a thinning circuit.

This is a counterpart of Japanese patent application Serial Number 193289/2007, filed on Jul. 25, 2007, the subject matter of which is incorporated herein by reference.

### BACKGROUND OF THE INVENTION

1. Field of the Invention

The present invention relates to a communication system and a method for communicating data using quadrature amplitude modulation (QAM) and a receiving apparatus and a method for the same.

2. Description of the Related Art

There is a trade-off between data rate and communication quality of sent/received data. Since communication quality varies with time in most sent/received radio communication and some wired communication, in communication systems such as ADSL (asymmetric digital subscriber line) or radio communication, total communication quality is improved generally by dynamically changing the data rate. For example, changing the symbol rate, changing the number of bits per one symbol, or changing the code rate of the error correcting code etc., can be used as techniques for changing data rate.

For example, in some sending apparatuses of conventional communication systems, the modulation method for transmission is changed to 16QAM or 64QAM responsive to command from a control unit, so as to change the number of bits per symbol. In 16QAM, 4 bits are assigned to a symbol. In 64QAM, 6 bits are assigned to a symbol. Furthermore, in the above system, the receiving apparatus similarly changes demodulation to 16QAM or 64QAM responsive to command from the control unit.

In the aforementioned sending apparatus, 16QAM mapping is performed to place 16 points evenly on a plane of orthogonal coordinates of the I-channel and the Q-channel, and 4-bit data is assigned to every one of the 16 points. The above-mentioned “evenly” means a state wherein mutual distances between every point become equal to each other. To a predetermined point on the coordinates of the I-channel and the Q-channel, any data can be assigned by assigning 4-bit data of 16QAM corresponding to both sending and receiving. However, it is preferable that a number of bits are assigned differently from the bit pattern of an adjacent point. That is, it is preferable that a Hamming distance is set to be 1. The sending signal of 16QAM can be categorized as a gray code by setting the Hamming distance of every point to be 1.

In addition, in the sending system described in Japanese Patent Application Laid-Open Publication Number H08-265160, the signal assignment process can be shared independently from modulation methods by using sequentially a plurality of bits from the LSB (lowest significant bit) side in a number corresponding to the modulation method, and for example, a signal constellation for uncoded bits can be shared independently from the modulation method, for example for both 16QAM and 64QAM.

In the above method, the receiving signal is divided into uncoded bits and coded bits. The uncoded bits are hard-decided with respect to each sub-bit, and the coded-bits are coded again after being encoded. The decision results of the uncoded bits are input to the uncoded-bit selector, and a representing symbol corresponding to the coded bits being coded again is selected and output as the encoded data. In the above process, only two uncoded bits from the LSB are used in the case of 16QAM, and only four uncoded bits from the LSB are used in the case of 64QAM.

However, in a conventional digital communication system, data rate cannot be changed accurately unless the modulation method is changed at the same timing during mapping in the sending apparatus and demapping in the receiving apparatus. In addition, the sending and receiving apparatuses need to include a plurality of mapping circuits and demapping circuits, increasing circuit volume.

Also, in order to match the timings for changing the data rate at the sending side and the receiving side, the data can be divided into blocks called packets, and a bit string including control information called a header can be added to the head of each of the packets. However, in the above case, since the header for designating the modulation method needs to be modulated by 16QAM and only the header cannot be sent, the data rate is decreased. Furthermore, additional processes such as analysis of header content and changing data rate according to analysis results etc., are necessary.

### SUMMARY OF THE INVENTION

In order to solve the above problems, it is an object of the present invention to provide a communication apparatus and corresponding communication method, and a receiving apparatus and receiving method that eliminates the disadvantages of conventional technology and that efficiently changes the QAM modulation methods.

To achieve this object, according to the present invention, there is provided a digital communication system for sending and receiving packet data at a data rate corresponding to a QAM method selected from a plurality of QAM methods, the digital communication system characterized by including a sending circuit and a receiving circuit. The sending circuit adds cyclic redundancy check (CRC) bits to the sending data, selects a QAM method from the plurality of QAM methods, maps the sending data correspondingly to the selected QAM method from a plurality of mappings corresponding to the plurality of QAM methods, and modulates and sends the data after being mapped. The receiving circuit demodulates the received data, demaps the demodulated data in the predetermined manner, performs CRC detection on the data after demapping in the predetermined manner, and thins the data after demapping in the predetermined manner in the case where CRC detection fails.

To achieve this object, there is also provided a digital communication method for sending and receiving packet data at a data rate corresponding to a QAM method selected from a plurality of QAM methods, the digital communication method characterized by including a sending process and a receiving process. In the sending process, cyclic redundancy check (CRC) bits are added to the sending data, the sending data is mapped correspondingly to the selected QAM method from a plurality of mappings corresponding to the plurality of QAM methods, and the data after being mapped is modulated and sent. In the receiving process, the received data is demodulated, CRC detection is performed on the data after being demapped in a predetermined manner, and the data after being demapped in the predetermined manner is thinned in the case where the CRC detection fails.

Furthermore, there is provided a receiving apparatus for receiving packet data sent at a data rate corresponding to a QAM method selected from a plurality of QAM methods after being mapped correspondingly to the selected QAM method, the receiving apparatus characterized by including a receiving process wherein the above packet with CRC bits added thereto is received, the received data is demodulated, CRC detection is performed on the data after being demapped in the predetermined manner; and the data after being demapped in the predetermined manner is thinned in the case where the CRC detection fails.

In addition, there is provided a receiving method for receiving packet data sent at a data rate corresponding to a QAM method selected from a plurality of QAM methods after being processed by the mapping process corresponding to the selected QAM method, the receiving method is characterized by including a receiving process wherein the above packet with CRC bits added thereto is received, the received data is demodulated, CRC detection is performed on the data after being demapped in a predetermined manner, and the data after being demapped in the predetermined manner is thinned in the case where the CRC detection fails.

According to the digital communication system of the present invention, the mapping circuit of the sending apparatus overlaps the 16QAM symbols with the 64QAM symbols on the constellation planes, composes the bit string so that the upper 4 bits of the overlapped 16 symbols of 64QAM symbols becomes the same as the 4 bits of the 16QAM symbols, and generates the sending data so that the code is categorized as a gray code in the case of either 64QAM or 16QAM. Therefore, the receiving apparatus for the sending data having the above configuration can carry out the 16QAM demapping by deleting the lower 2 bits of the received data after being 64QAM demapped, so that a 16QAM demapping circuit does not need to be included in the receiving apparatus.

In addition, according to the digital communication system of the present invention, since the sending apparatus generates the sending data adding the CRC bits thereto, the data rate for sending the data can be decided automatically according to the CRC detection result by demodulating the received data by the 64QAM method in the case where the data was modulated by the 16QAM method. Consequently, a header for informing the receiving side of changing data rate as sent from the sending side becomes unnecessary, and data rate is improved. Additionally, analysis of the content of the header becomes unnecessary. Therefore, the system can be simplified.

### BRIEF DESCRIPTION OF THE DRAWINGS

The above and other aspects and features of the present invention will become readily apparent from the detailed description that follows, with reference to the accompanying drawings, in which:

FIG. 1 is a block diagram of a sending apparatus according to an embodiment of the present invention.

FIG. 2 is a block diagram of a receiving apparatus according to an embodiment of the present invention.

FIG. 3 is a symbol constellation assigned by 16QAM in the sending apparatus according to the embodiment of FIG. 1.

FIG. 4 is a symbol constellation assigned by 64QAM in the sending apparatus according to the embodiment of FIG. 1.

FIG. 5 is a symbol-string example mapped by the sending apparatus according to the embodiment of FIG. 1.

FIG. 6 is a sequence chart showing operation sequences in the sending apparatus and receiving apparatus according to the embodiments of FIG. 1 and FIG. 2.

FIG. 7 is a view of a bit string of 16QAM processed by the sending apparatus according to the embodiment of FIG. 1.

FIG. 8 is a view of a bit string of 16QAM of FIG. 7 having added CRC bits.

FIG. 9 is a view of a symbol string transformed by 16QAM mapping from the 16QAM bit-string of FIG. 8.

FIG. 10 is a view of a bit string transformed by 64QAM demapping from the 16QAM bit-string of FIG. 9 in the receiving apparatus according to the embodiment of FIG. 2.

FIG. 11 is a view of a bit string of 64QAM processed by the sending apparatus according to the embodiment of FIG. 1.

FIG. 12 is a view of a bit string of 64QAM of FIG. 11 having added CRC bits.

FIG. 13 is a view of a symbol string transformed by 64QAM mapping from the 64QAM bit-string of FIG. 12.

### DETAILED DESCRIPTION OF THE PREFERRED EMBODIMENTS

The present invention will now be described by way of preferred, but non-limiting embodiments of the invention. The referenced drawings are presented for illustrative purposes only, and are not intended to limit the scope of the invention.

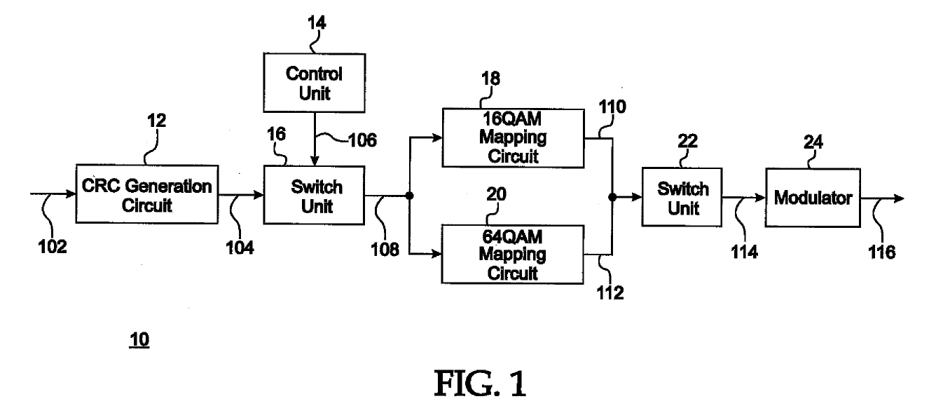

As shown in FIG. 1, sending apparatus 10 sends a sending signal based on a required packet in a variable data rate communication system using a quadrature amplitude modulation (QAM) method. As shown, a cyclic redundancy check (CRC) generating circuit 12 adds CRC bits to an input packet, a control unit 14 controls a switch unit 16 to provide the input packet to a 16QAM mapping circuit 18 or a 64QAM mapping circuit 20, and the mapped packet is transformed to a sending signal through a switch unit 22 by a modulator 24 for sending.

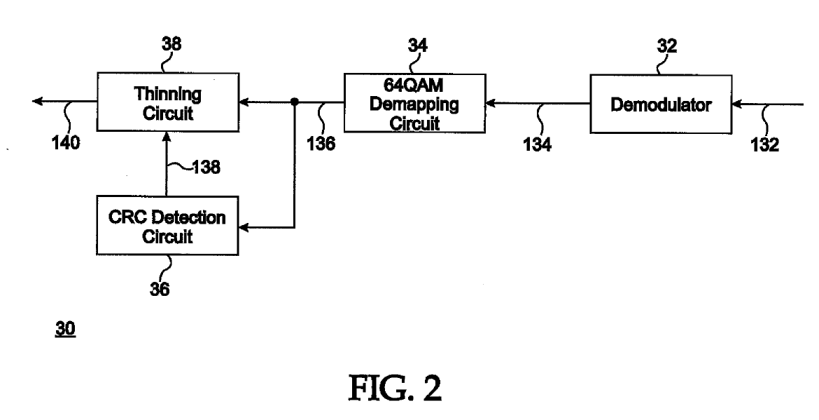

As shown in FIG. 2, receiving apparatus 30 receives signals sent from other apparatuses in the variable data rate communication system using a QAM method, and processes the received data. As shown, demodulation unit 32 transforms the received signal to a symbol string, a 64QAM demapping circuit 34 transforms the symbol to a bit string, a CRC detection circuit 36 detects CRC bits of the bit string, and a thinning circuit 38 thins the bit string according to the CRC detection result. The parts having nothing to do directly with understanding the present invention will be omitted in the figures to avoid a redundant explanation.

In greater detail, the digital communication system according to the present invention sends and receives packet data at a data rate corresponding to one method selected out of a plurality of modulation methods.

In sending apparatus 10 shown in FIG. 1, CRC generation circuit 12 has input thereto a packet 102 of data to be sent, in other words a bit string, and generates CRC bits for example, according to a predetermined generator polynomina. Furthermore, the CRC generation circuit 12 generates a new packet 104 by adding the CRC bits to the packet 102, and provides the packet 104 to a switch unit 16.

The control unit 14 selects a modulation method for signals to be sent by the sending apparatus 10, and provides a control signal 106 indicative of the selecting result to the switch unit 16. For example, the control unit 14 changes the switch circuit to set the data rate to the low-speed rate (16QAM) or the high-speed rate (64QAM), based on measured communication quality of the transmission channel. The control unit 14 controls the switch unit 16 so that the switch unit 16 provides packet data 108 to 16QAM mapping circuit 18 in the case where the sending data needs to be sent by 16QAM, and to 64QAM mapping circuit 20 in the case where the sending data needs to be sent by 64QAM. The switch unit 16 switches the path to 16QAM mapping circuit 18 or 64QAM mapping circuit 20 according to control signal 106, and provides the packet data 108 to the mapping circuits 18 or 20.

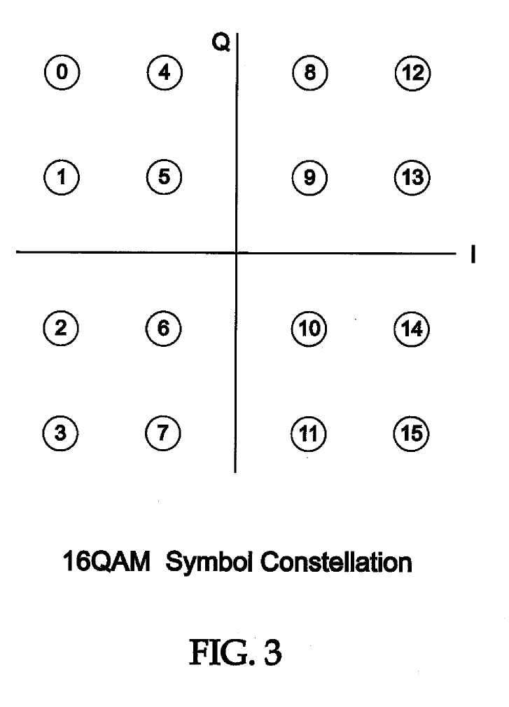

The 16QAM mapping circuit 18 carries out mapping by assigning 4 bits to one symbol based on the packet 108 provided through the switch unit 16, outputs a constellation signal 110 indicating the symbol string of the mapping result, and provides the constellation signal 110 to the modulator 24 through the switch unit 22. As shown in FIG. 3, in the 16QAM mapping process, 16 points are evenly assigned on the plane of the orthogonal coordinates of the I and Q channels, symbols are generated by assigning 4-bit data for each of the points, and the 16QAM constellation signal 110 of a gray code is preferably generated.

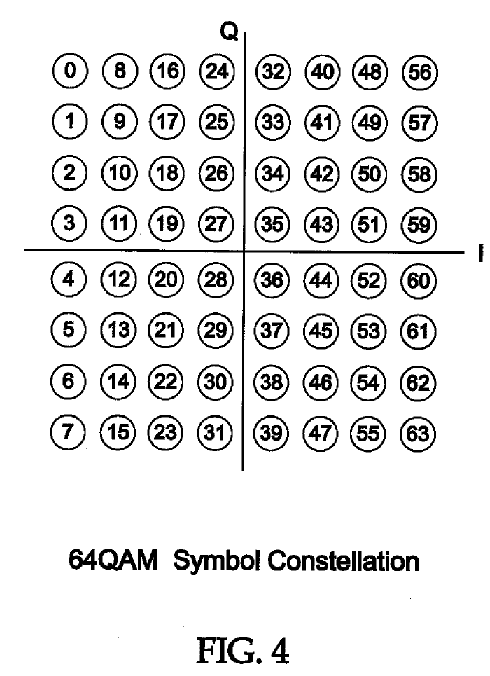

Similarly as the 16QAM mapping circuit 18, the 64QAM mapping circuit 20 carries out mapping by assigning 6 bits to one symbol based on the packet 108 provided through the switch unit 16, outputs a constellation signal 112 indicating the symbol string as the mapping result, and provides the constellation signal 112 to the modulator 24 through the switch unit 22. As shown in FIG. 4, in the 64QAM mapping process, 64 points are evenly assigned on the plane of the orthogonal coordinates of the I and Q channels, symbols are generated by assigning 6-bit data for each of the points, and the 64QAM constellation signal 112 of a gray code is preferably generated.

According to the present embodiment, the mapping circuits 18 and 20 assign the equivalent two sets of 16 symbols out of 16QAM symbols and the 64QAM symbols so as to overlap each other on the I Q plane, arrange the bit string so that 4 bits of the 16QAM symbol becomes identical to the upper 4 bits of the 64QAM symbol, and generates the constellation signals 110 and 112, respectively.

For example, each of the points according to the 16QAM mapping and the 64QAM mapping are placed as shown in FIG. 3 and FIG. 4, and each of the placed points are shown by circled numbers. For example, in FIG. 3 and FIG. 4, the circled numbers 0, 1, 2, 3, 4, . . . 15 of the 16QAM mapping are correspondingly overlapped with the circled numbers 0, 2, 5, 7, 16, . . . 63 of the 64QAM mapping, respectively.

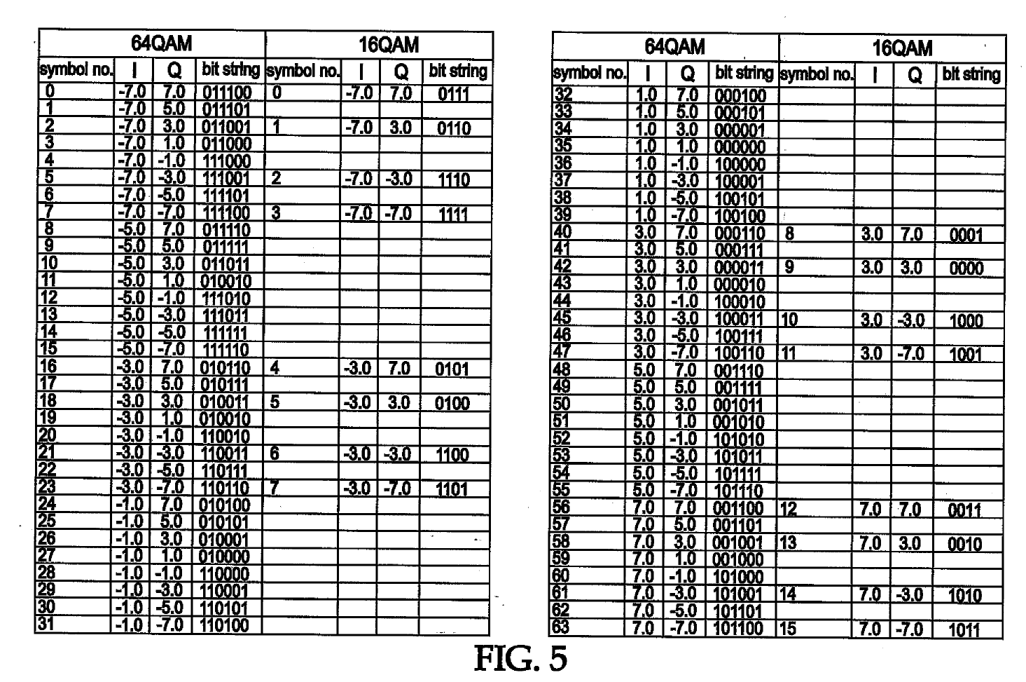

In the case where the 16QAM mapping circuit 18 and the 64QAM mapping 20 according to the present embodiment map a predetermined bit string 108, the mapping circuits generate the symbol strings 110 and 112 by parallelizing the points overlapped with each other, as shown in FIG. 5. In FIG. 5, the symbol number represents the order of the symbols in the symbol strings 110 and 112, and the I value and the Q value represent the value of each point in the symbol strings 110 and 112.

In FIG. 1, the switch unit 22 provides the constellation signals 110 and 112 respectively output from the mapping circuits 18 and 20 to modulator 24 as a constellation signal 114. The modulator 24 modulates the constellation signal 114, and transforms the modulated signal to a sending signal 116 for sending.

In the receiving apparatus shown in FIG. 2, demodulating unit 32 demodulates a received signal 132 received from the outside, transforms the demodulated signal to a symbol string 134, and provides the transformed signal to a 64QAM demapping circuit 34. The 64QAM demapping circuit 34 demaps symbol string 134 by 64QAM, transforms the demapped string to a bit string 136, and provides the bit string 136 to CRC detection circuit 36 and thinning circuit 38.

The CRC detection circuit 36 detects the CRC bit in the bit string 136 provided from the demapping circuit 34, and controls thinning circuit 38 by providing a control signal 138 to the thinning circuit 38 according to the detection result thereof. In the case where CRC bits cannot be detected, the CRC detection circuit 36 outputs the control signal 138 for instructing thinning. In other words, in the case where CRC bits can be detected correctly, the CRC detection circuit 36 instructs thinning circuit 38 not to thin bit string 136 input to thinning circuit 38, and to output the bit string 136 directly, judging that a received signal 132 has been sent by 64QAM. Meanwhile, in the case where CRC cannot be detected, or is detected incorrectly, the CRC detection circuit 36 instructs thinning circuit to thin bit string 136, judging that received signal 132 of receiving apparatus 30 has been sent by 16QAM.

Thinning circuit 38 carries out thinning of bit string 136 as noted above according to the control signal 138 from the CRC detection circuit 36. In the case where the CRC bits can be detected by the CRC detection circuit 36, the thinning circuit 38 of the present embodiment outputs the input bit string 136 directly to the subsequent process as a bit string 140, judging that the received signal 132 has been sent by 64QAM. In the case where the CRC bits cannot be detected, the thinning circuit 38 thins unnecessary bits of the bit string 136 to output the bit string 140 to the subsequent process, judging that the received signal 132 has been sent by 16QAM. The thinning circuit 38 carries out the thinning processing for example, in the case where the received signal modulated by 16QAM is demodulated. In other words, thinning circuit 38 carries out thinning by eliminating or deleting the lower 2 bits out of the 6 bits per one symbol of the bit string 136, as unnecessary bits.

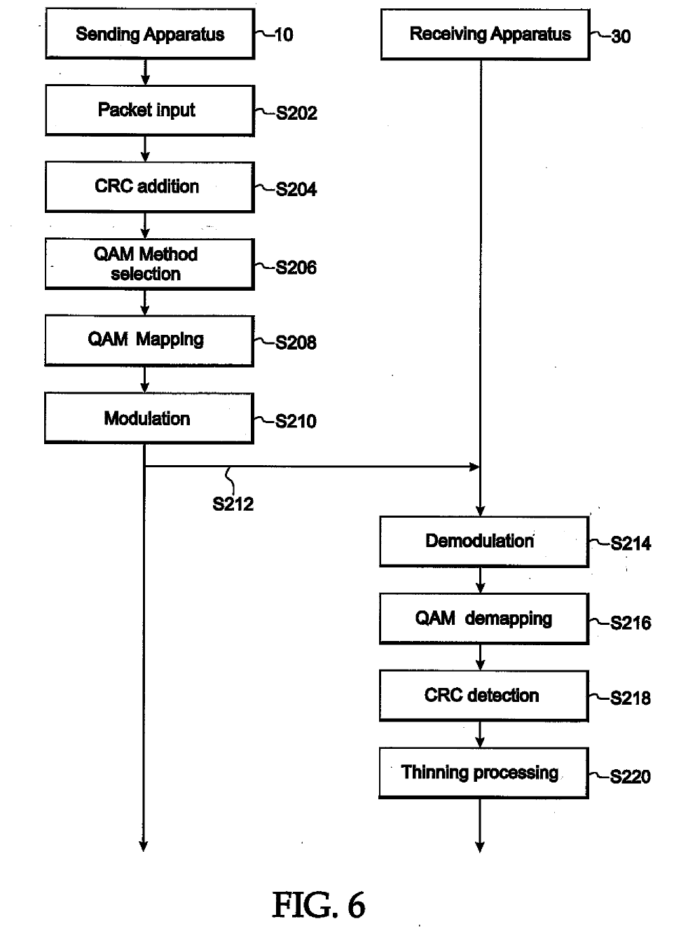

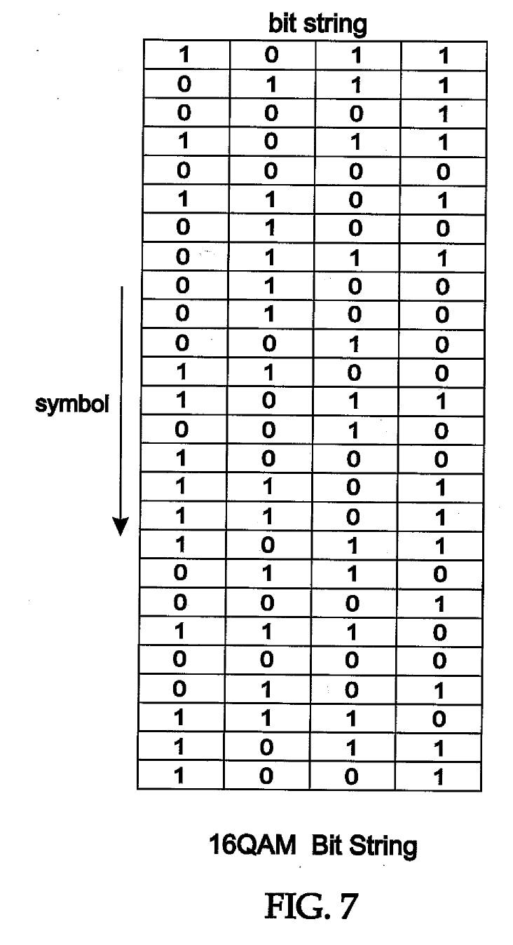

An operation example for sending and receiving packet data by 16QAM using the sending apparatus 10 and the receiving apparatus 30 of the present invention will be explained, referring to a sequence chart of FIG. 6. According to the present embodiment, when the sending process of the packet data 102 is started by the sending apparatus 10, the packet data 102 is first provided to the CRC generation circuit 12 (S202), and the packet data 102 of 104 bits shown as in FIG. 7 for example, is input to the CRC generation circuit 12. In the case of FIG. 7, since the data 102 is to be sent by 16QAM, 4 bits are assigned to one symbol.

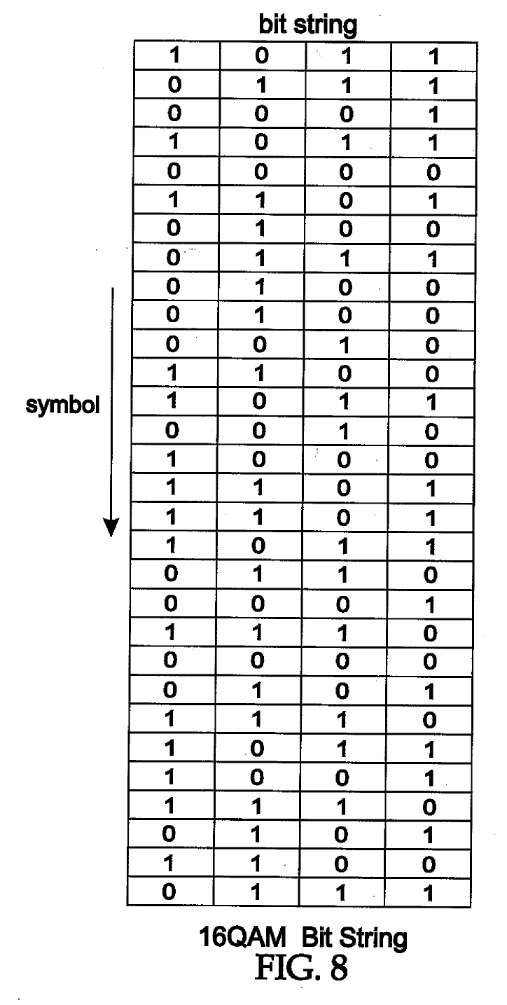

In the CRC generation circuit 12, after the CRC bits are generated by adapting the polynomial CRC-16 defined by Comite Consultaif International Telegraphique et Telephonique (CCITT) for example, 16 CRC bits are added to the packet data 102 of 104 bits to generate the packet data 104 of 120 bits (S204) as shown in FIG. 8, and the packet data 104 is provided to the switch unit 16.

Furthermore, in the control unit 14 of the sending apparatus 10, the modulation method for sending the packet data 102 is selected (S206). According to the present embodiment, 16QAM is selected, and a control signal 106 corresponding to the selection result is provided to the switch unit 16. The packet data 104 input to the switch unit 16 is provided to 16QAM mapping circuit 18 as packet data 108, responsive to the control signal 106.

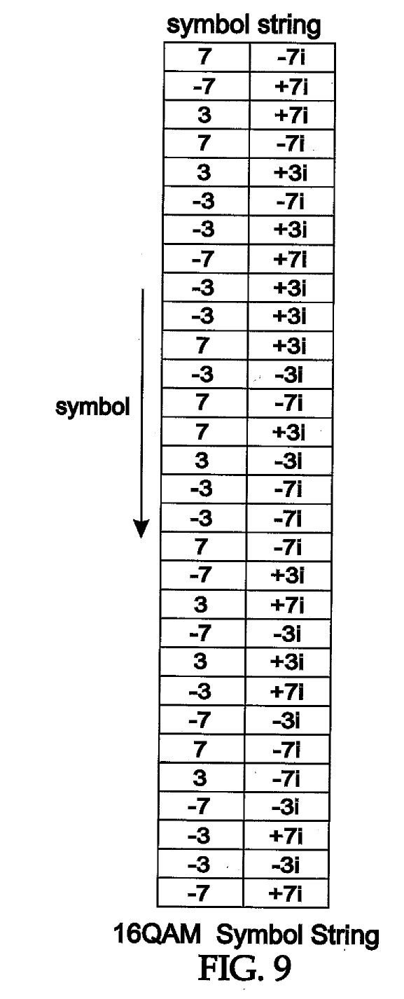

In the 16QAM mapping circuit 18, the packet data 108 of 120 bits is mapped by 16QAM (S208) to be transformed to a constellation signal 110 representing a 30-symbol string as shown in FIG. 9, and the constellation signal 110 is provided to modulator 24 through switch unit 22. In the above process, the packet data 108 is processed by 16QAM mapping parallelized to 64QAM mapping, as described previously.

In the modulator 24, a constellation signal 114 provided through the switch unit 22 is modulated (S210) to generate a sending signal 116, and the sending signal 116 is sent to the receiving apparatus 30 (S212).

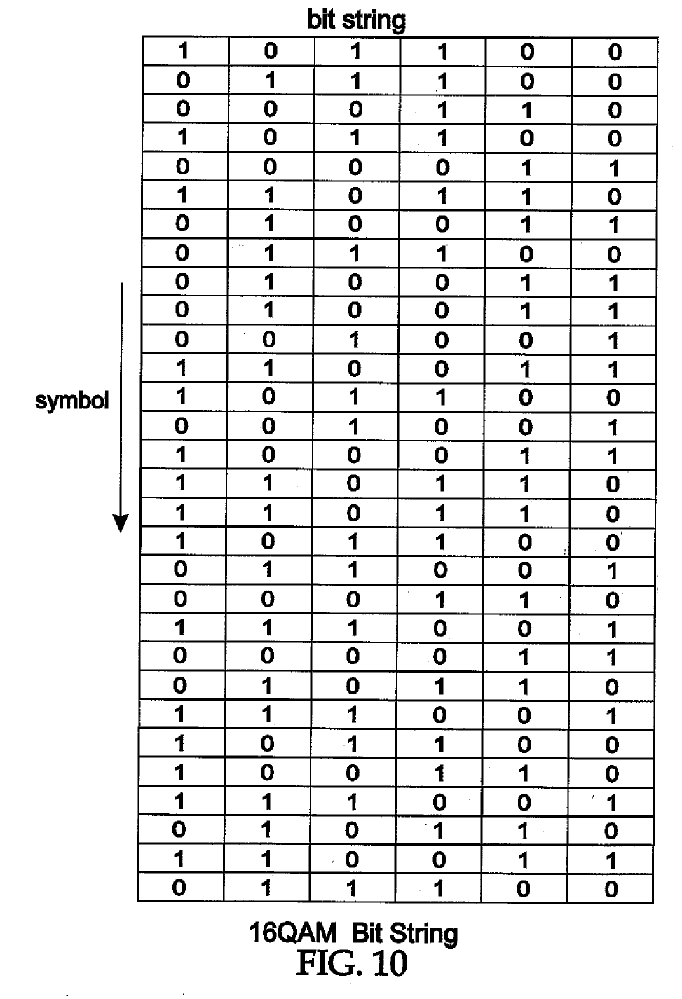

Meanwhile, in the receiving apparatus 30 of the present embodiment as shown in FIG. 2, when the sending signal 116 from the sending apparatus 10 is received as the received signal 132, the received signal 132 is first provided to the modulator 32 to be demodulated (S214) into symbol string 134. The symbol string 134 is provided to the 64QAM demapping circuit 34 to be demapped by 64QAM (S216). According to the present embodiment, the symbol string 134 is transformed to 30 symbols of the bit string 136 having 6 bits per one symbol as shown in FIG. 10, and is provided to the CRC detection circuit 36 and the thinning circuit 38.

In the CRC detection circuit 36, detection of the CRC bits is performed based on the bit string 136 (S218). In the bit string 136 shown in FIG. 10, since the lower 2 bits of each symbol are extra bits added by 64QAM demapping of the 16QAM mapped data, CRC checking fails. The control signal 138 for instructing thinning is provided to the thinning circuit 38. In the thinning circuit 38, the bit string 136 is thinned responsive to the control signal 138 (S220), and the lower 2 bits of each symbol are eliminated to generate a correct bit string 140 having 4 bits per one symbol. Subsequently, the above bit string 140 is provided to a necessary subsequent process in the receiving circuit 30. Incidentally, in the above process, it is also possible that the received signal 132 has been sent by 16QAM and the CRC check by the CRC detection circuit 36 has failed.

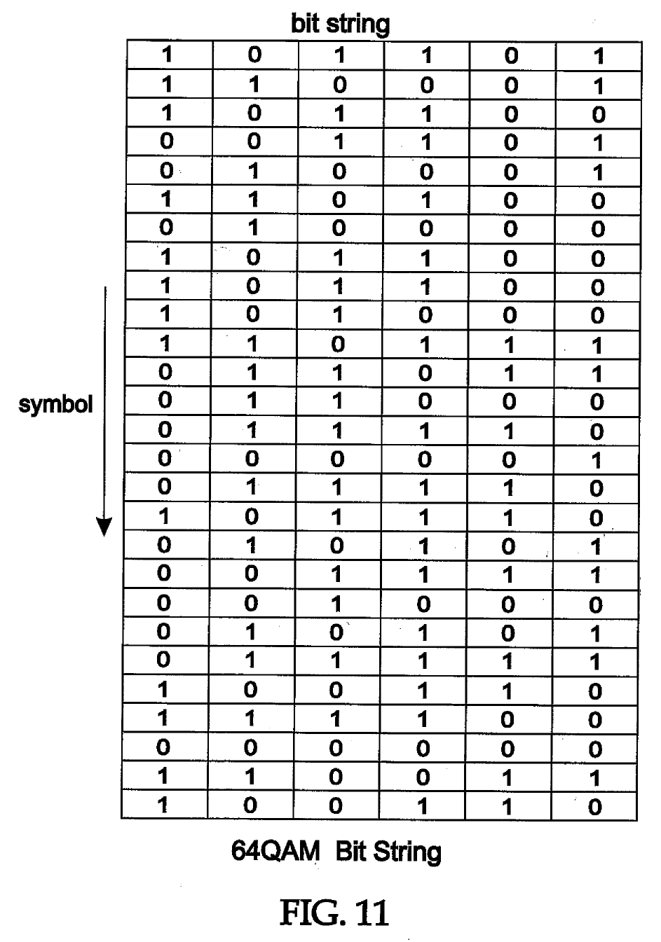

An operation example for sending and receiving packet data by 64QAM using the sending apparatus 10 and the receiving apparatus 30 of the present invention will now be explained, referring to the sequence chart of FIG. 6. According to the present embodiment, when the sending process of the packet data 102 is started by the sending apparatus 10 shown in FIG. 1, the packet data 102 is first provided to the CRC generation circuit 12 (S202), and the packet data 102 of 164 bits as shown in FIG. 11 for example, is input to the CRC generation circuit 12. In the case of FIG. 11, since the data 102 is sent by 64QAM, 6 bits are assigned to one symbol.

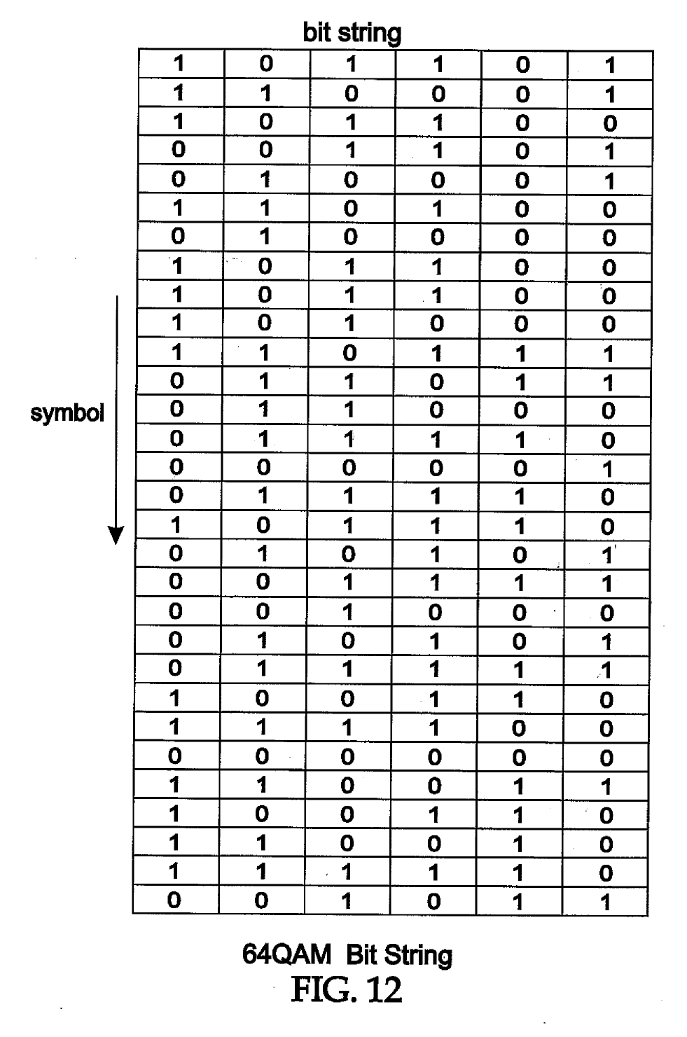

In the CRC generation circuit 12, after the CRC bits are generated by adapting the polynomial CRC-16 defined by CCITT, for example 16 CRC bits are added to the packet data 102 of 164 bits to generate the packet data 104 of 180 bits (S204) as shown in FIG. 12, and the packet data 104 is provided to the switch unit 16.

Furthermore, in the control unit 14 of the sending apparatus 10, the QAM modulation method for sending is selected (S206). According to the present embodiment, 64QAM is selected, and a control signal 106 corresponding to the selection result is provided to the switch unit 16. The packet data 104 input to the switch unit 16 is provided to 64QAM mapping circuit 20 as packet data 108, responsive to the control signal 106.

In the 64QAM mapping circuit 20, the packet data 108 of 180 bits is mapped according to 64QAM (S208) to be transformed to a constellation signal 112 representing a 30-symbol string as shown in FIG. 9, and the constellation signal 110 is provided to modulator 24 through a switch unit 22. In the modulator 24, similarly as in the above-mentioned process, a constellation signal 114 provided from the switch unit 22 is modulated (S210) to generate a sending signal 116, and the sending signal 116 is sent to the receiving apparatus 30 (S212).

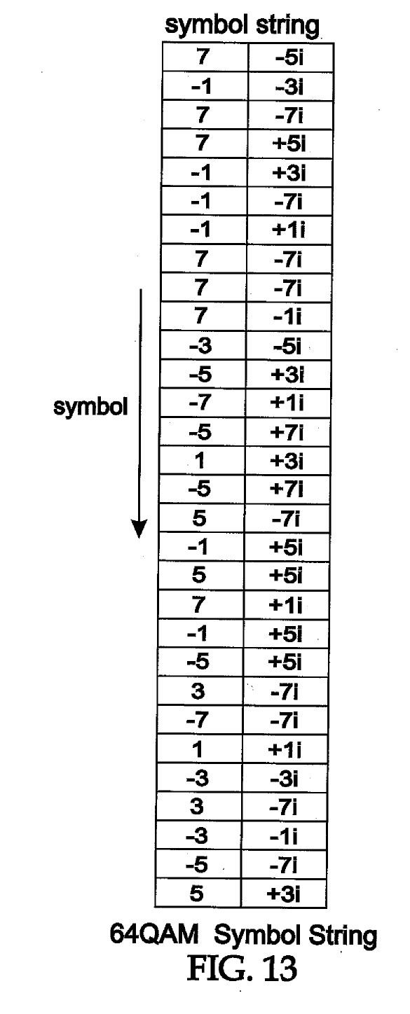

Meanwhile, in the receiving apparatus 30 as shown in FIG. 2, when the sending signal 116 from the sending apparatus 10 is received as the received signal 132, similarly as in the above-mentioned process, the received signal 132 is demodulated by the modulator 32 (S214) to the symbol string 134, and a symbol string 134 is restored as shown in FIG. 13. The above symbol string 134 is demapped using 64QAM by the 64QAM demapping circuit 34 (S216) to be transformed to the bit string 136 having 6 bits per one symbol, and the bit string 136 is provided to the CRC detection circuit 36 and the thinning circuit 38.

In the CRC detection circuit 36, detection of the CRC bits is performed based on the bit string 136 (S218). According to the present embodiment, since the CRC checking does not fail, it is possible that the received signal 132 has been sent by 64QAM, and then the control signal 138 instructing not to thin is provided to the thinning circuit 38. In the thinning circuit 38, the bit string 136 is not thinned responsive to the above control signal 138, and the above bit string 136 is directly provided to a required subsequent process in the receiving circuit 30, as the bit string 140.

The present invention should not be limited to the above described embodiments. For example, the sending modulation system used in the sending apparatus 10 and the receiving apparatus 30 can be configured to be combined with other communication systems such as orthogonal frequency division multiplex (OFDM) systems, for example. These modifications can be made to the embodiments described above while still falling within the scope of the appended claims.

What is claimed is:

1. A digital communication system for sending and receiving packet data at a data rate corresponding to a quadrature amplitude modulation (QAM) method selected from among a plurality of QAM methods, the digital communication system comprising:
a transmitter that adds cyclic redundancy check (CRC) bits to sending data, selects a QAM method from among the plurality of QAM methods, maps the sending data using a mapping corresponding to the selected QAM method and as selected from among a plurality of mappings corresponding to the plurality of QAM methods, modulates the mapped sending data, and sends the modulated data; and
a receiver that receives the sent data, demodulates the received data, demaps the demodulated data using a predetermined demapping, carries out CRC detection on the demapped demodulated data, and thins the demapped demodulated data upon failure of the CRC detection.

2. The digital communication system of claim 1, wherein the plurality of mappings and the predetermined demapping are performed so that a symbol constellation of a QAM method having a lower speed data rate from among the plurality of QAM methods is correspondingly overlapped with a symbol constellation of a QAM method having a higher speed data rate from among the plurality of QAM methods.

3. The digital communication system of claim 2, wherein the QAM method having the lower speed data rate is 16QAM, the QAM method having the higher speed data rate is 64QAM, the transmitter carries out mapping corresponding to any of 16QAM and 64QAM as the plurality of QAM methods, the receiver receives the sent data at a data rate corresponding to any of 16QAM and 64QAM as the plurality of QAM methods, and the receiver carries out 64QAM demapping as the predetermined demapping independently of the data rate of the sending data.

4. The digital communication system of claim 3, wherein the plurality of mappings and the predetermined demapping are performed so that the upper 4 bits out of 6 bits assigned to a symbol by 64QAM become the same as 4 bits assigned to the symbol by 16QAM, and the thinning deletes the lower 2 bits of the demodulated data demapped using the predetermined demapping.

5. A communication method for sending and receiving packet data at a data rate corresponding to a quadrature amplitude modulation (QAM) method selected from among a plurality of QAM methods, the communication method comprising:
sending the packet data by adding CRC bits to sending data, selecting a QAM method from among the plurality of QAM methods, mapping the sending data using a mapping corresponding to the selected QAM method and as selected from among a plurality of mappings corresponding to the plurality of QAM methods, modulating the mapped sending data, and sending the modulated data; and
receiving the sent data which includes demodulating the received data, demapping the demapped data using a predetermined demapping, performing CRC detection on the demapped demodulated data, and thinning the demapped data upon failure of the CRC detection.

6. The communication method of claim 5, wherein the plurality of mappings and the predetermined mapping are performed so that a symbol constellation of a QAM method having a lower speed data rate from among the plurality of QAM methods is correspondingly overlapped with a symbol constellation of a QAM method having a higher speed data rate from among the plurality of QAM methods.

7. The communication method of claim 6, wherein the QAM method having the lower speed data rate is 16QAM, the QAM method having the higher speed data rate is 64QAM, mapping is performed corresponding to any of 16QAM and 64QAM as the plurality of QAM methods, the modulated data is sent at a data rate corresponding to any of 16QAM and 64QAM as the plurality of QAM methods, and 64QAM demapping is performed as the predetermined demapping independently of the sending data rate of the received data.

8. The communication method of claim 7, wherein the plurality of mappings and the predetermined demapping are performed so that the upper 4 bits of 6-bits assigned to a symbol by 64QAM become the same as 4 bits assigned to a symbol by 16QAM, and the thinning deletes the lower 2 bits of the demodulated data demapped using the predetermined demapping.

9. A receiving apparatus for receiving packet data that has been mapped using any of a plurality of quadrature amplitude modulation (QAM) methods and sent at a data rate corresponding to a selected one of the QAM methods, the receiving apparatus comprising:
a receiving circuit that receives the packet data;
a demodulating circuit that demodulates the received data;
a demapping circuit that demaps the demodulated data using a predetermined demapping;
a CRC detection circuit that detects from the demapped data whether CRC bits were added to the packet data sent to the receiving apparatus; and
a thinning circuit that thins the demapped data upon failure of detection of CRC bits.

10. The receiving apparatus of claim 9, wherein the receiving apparatus receives the packet data which is mapped so that a symbol constellation of a QAM method having a lower speed data rate out of the plurality of QAM methods is correspondingly overlapped with a symbol constellation of a QAM method having a higher speed data rate out of the plurality of QAM methods.

11. The receiving apparatus of claim 10, wherein the QAM method having the lower speed data rate is 16QAM, the QAM method having the higher speed data rate is 64QAM, the receiving apparatus receives the packet data that is mapped corresponding to any of 16QAM and 64QAM as the plurality of QAM methods and sent at a data rate corresponding to any of 16QAM and 64QAM as the plurality of QAM methods, and the receiver apparatus performs 64QAM demapping as the predetermined demapping independently of the data rate of the received packet data.

12. The receiving apparatus of claim 11, wherein the receiving apparatus receives the packet data that is mapped so that the upper 4 bits of 6 bits assigned to a symbol by 64QAM becomes the same as 4 bits assigned to the symbol by 16QAM, and the thinning circuit deletes the lower 2 bits demapped using the predetermined demapping.

13. A receiving method for receiving a packet data that has been mapped using any of a plurality of quadrature amplitude modulation (QAM) methods and sent at a data rate corresponding to a selected one of the QAM methods, the receiving method comprising:
receiving the packet data;
demodulating the receiving data;
demapping the demodulated data using a predetermined demapping;
performing CRC detection that detects from the demapped data whether CRC bits were added to the packet data received; and
thinning the demapped data upon failure of detection of CRC bits.

14. The receiving method of claim 13, wherein the packet data is mapped so that a symbol constellation of a QAM method having a lower speed data rate out of the plurality of QAM methods is correspondingly overlapped with a symbol constellation of a QAM method having a higher speed data rate out of the plurality of QAM methods.

15. The receiving method of claim 14, wherein the QAM method having the lower speed data rate is 16QAM, the QAM method having the higher speed data rate is 64QAM, and the packet data is mapped corresponding to any of 16QAM and 64QAM as the plurality of QAM methods and sent at a data rate corresponding to any of 16QAM and 64QAM as the plurality of QAM methods, and the receiving method includes 64QAM demapping as the predetermined demapping independently of the data rate of the received packet data.

16. The receiving method of claim 15, wherein the receiving method includes receiving the packet data that is mapped so that the upper 4 bits of 6 bits assigned to a symbol by 64QAM becomes the same as 4 bits assigned to the symbol by 16QAM, the plurality of mappings and the predetermined demapping of the packet data being mapped so that the upper 4 bits of the 6 bits assigned to the symbol by 64QAM become the same as the 4 bits assigned to the symbol by 16QAM, and the thinning deletes the lower 2 bits demapped using the predetermined demapping.
